(19) United States
(12) Patent Application Publication
(10) Pub. No.: US 2016/0078219 A1
(43) Pub. Date: Mar. 17, 2016

(54) AUTHENTICATION USING PROOF OF WORK AND POSSESSION

(71) Applicant: Microsoft Corporation, Redmond, WA (US)

(72) Inventor: Shawn V. Hernan, Redmond, WA (US)

(21) Appl. No.: 14/486,864

(22) Filed: Sep. 15, 2014

(51) Int. Cl. G06F 21/46

(52) U.S. Cl. CPC G06F 21/46

(57) ABSTRACT

Password-based authentication in which the authenticating entity uses proof of work based on the password as well as proof of possession of the password in order to authenticate to an authentication system, both of which provided by the authenticating entity to the authentication system at setup. In subsequent authentication attempts, the authentication system will compare any proof of possession and proof of work received in the request against this initially set up proof of possession and proof of work to perform authentication. The authentication system might perform work on the proof of work to generate a further proof of work that is then compared against a further proof of work that the authentication system generated at the time the authentication mechanism was originally set up. Upon subsequent authentication requests, the authenticating entity need not regenerate the proof of work, but instead provides the stored proof of work.

### BACKGROUND

Computing systems and associated networks have revolutionized the way human beings work, play, and communicate. Nearly every aspect of our lives is affected in some way by computing systems. Computing systems are now largely connected to networks and the Internet so as to enable widespread communications. The vast capabilities of such computing networks have resulted in the proliferation of distributed computing and a variety of services and resources being offered over networks. Authentication technologies are aimed at allowing one computing system (often a requestor of a service, such as a client) or its user to authenticate their identity to another computing system (often a provider of a service, such as a server) or its user.

One class of authentication is referred to as single factor authentication in which the client provides a secret (such as a password or token) to the server. If the secret matches the secret that the server has for that client, or if a one way algorithm result (such as a hash) of the secret matches the one way algorithm result that the server has stored for that client, then the server determines that the client is authenticated.

Attackers can attempt to guess secrets (especially passwords) over the internet by simple brute force—that is attempting numerous secrets in a rapid sequential fashion until alas the secret is found. Similarly, if a secrets database is lost or stolen, an attacker can guess the secrets offline, without triggering any sort of alarm. Unfortunately, passwords that humans select for purposes of being easily remembered are often likewise easily guessable, in which case these attacks are not necessarily difficult. Traditionally, the security of an individual password is dependent on the technical and procedural controls implemented by a service, and thus a given user is highly dependent on the service for their own security. Furthermore, the traditional techniques for hardening passwords at the server perform repeated application of a one-way function, slowing down the login process and resulting in poor scalability. Likewise, traditional security controls for passwords often impose computational cost on the server, resulting in poor scaling.

Other traditional authentication technologies are referred to as “two-factor authentication”, or more generally “multi-factor authentication”. Two-factor authentication systems are more secure in that an attacker cannot compromise a target system unless the attacker obtains both factors. As long as the authentication factors are chosen independently, the loss of a single authentication factor does not result in a compromise. Instead, the attacker must compromise both factors to compromise the target system. In practice the most common two-factor authentication systems involve some sort of password or PIN (“something you know”) in combination with some sort hardware token (“something you have”) in such a way as to provide good assurance that merely losing the hardware token, or losing the password (but not losing both the password and the token) will not lead to compromise.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to password-based authentication in which the authenticating entity uses proof of work based on the password as well as proof of possession of the password in order to authenticate to an authentication system.

Some embodiments described herein related to the authenticating entity and the authentication system setting up such an authentication mechanism to be used for future authentication requests. For instance, the authenticating entity may submit the proof of work and proof of possession to the authentication system. In subsequent authentication attempts in which an authentication request is received at the authentication system, and that purports to be from the authenticating entity, the authentication system will compare any proof of possession and proof of work against this initially set up proof of possession and proof of work to perform authentication.

In some embodiments, the authentication system might perform work on the proof of work to generate a further proof of work that is then compared against a further proof of work that the authentication system generated at the time the authentication mechanism was originally set up. For instance, the authentication system might have performed that same further proof of work on the proof of work provided by the authenticating entity at setup of the authentication mechanism. As an example, the authenticating entity might request an amount of work to generate the proof of work and an amount of further work to be performed by the authentication entity, both subject to approval or constraints imposed by the authentication system.

The initial authentication setup may take some time due to the authenticating entity generating the proof of work. Upon subsequent authentication requests, however, the authenticating entity need not regenerate the proof of work (provided the authenticating entity has not lost or discarded the proof of work). Instead, the authenticating entity just generates a proof of possession, which is easier and faster to generate. Accordingly, subsequent authentications may be relatively fast. If the authenticating entity loses the proof of work, but still has the password, then the authenticating entity may still authenticate, but only after performing proof of work. The presence of a proof of work can be daunting to an attacker system that is attempting authentication for one password at a time, as authentication would not be completed presumably until the attacker guesses numerous incorrect passwords until the correct password, and each guess would involve regenerating a proof of work that is based on yet a different password.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 illustrates authentication environment that includes an authenticating entity, and an authentication system that communicate with each other over a channel to set up and use an authentication mechanism;

FIG. 3 illustrates a flowchart of a method for an authenticating entity to perform its part in setting up an authentication mechanism with an authentication system based on a password;

FIG. 4 illustrates a flowchart of a method for an authentication system to perform its part in setting up the authentication mechanism with the authenticating entity based on the password;

FIG. 5 illustrates a flowchart of a method for an authenticating entity to perform its part in authenticating with an authentication system based on a password and using the authentication mechanism established in FIGS. 3 and 4;

FIG. 6 illustrates a flowchart of a method for an authentication system to perform its part in authenticating the authenticating entity using the authentication mechanism established in FIGS. 3 and 4; and

FIG. 7 illustrates a flowchart of a method for authentication when the authenticating entity no longer has the proof of work or the catalyst.

### DETAILED DESCRIPTION

At least some embodiments described herein relate to password-based authentication in which the authenticating entity uses proof of work based on the password as well as proof of possession of the password in order to authenticate to an authentication system.

Some embodiments described herein related to the authenticating entity and the authentication system setting up such an authentication mechanism to be used for future authentication requests. For instance, the authenticating entity may submit the proof of work and proof of possession to the authentication system. In subsequent authentication attempts in which an authentication request is received at the authentication system, and that purports to be from the authenticating entity, the authentication system will compare any proof of possession and proof of work against this initially set up proof of possession and proof of work to perform authentication.

In some embodiments, the authentication system might perform work on the proof of work to generate a further proof of work that is then compared against a further proof of work that the authentication system generated at the time the authentication mechanism was originally set up. For instance, the authentication system might have performed that same further proof of work on the proof of work provided by the authenticating entity at setup of the authentication mechanism. As an example, the authenticating entity might request an amount of work to generate the proof of work and an amount of further work to be performed by the authentication entity, both subject to approval or constraints imposed by the authentication system.

The initial authentication setup may take some time due to the authenticating entity generating the proof of work. Upon subsequent authentication requests, however, the authenticating entity need not regenerate the proof of work (except in the less likely event the authenticating entity has lost the proof of work, the authenticating entity is authentication from a system in which the proof of work is not available, or the authenticating entity has elected to discard the proof of work). Instead, the authenticating entity just generates a proof of possession, which is easier and faster to generate. Accordingly, subsequent authentications may be relatively fast. If the authenticating entity loses the proof of work, but still has the password, then the authenticating entity may still authenticate, but only after performing proof of work.

The presence of a proof of work can be daunting to an attacker system that is attempting authentication for one password at a time, as authentication would not be completed presumably until the attacker guesses numerous incorrect passwords until the correct password, and each guess would involve regenerating a proof of work that is based on yet a different password. The legitimate authenticating entity, on the other hand, has no need to repeatedly attempt different passwords, at least not to the same extent (perhaps there was a mistype or temporary lapse in memory), and thus the proof of work is much less imposing when attempting authentication for legitimate purposes.

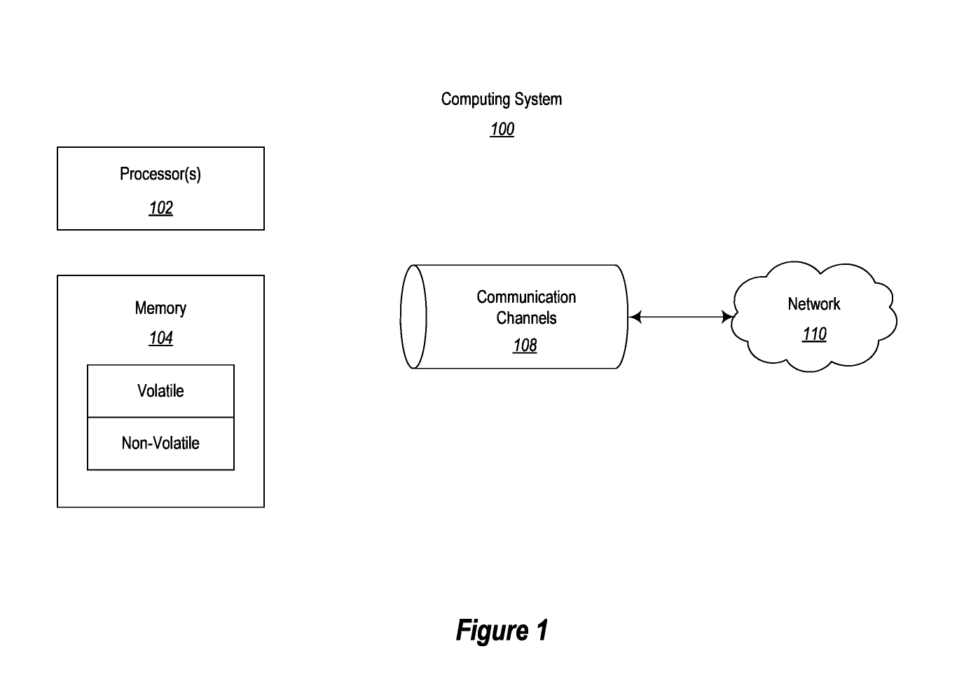

Some introductory discussion of a computing system will be described with respect to FIG. 1. Then, an example structure and operation of an authentication mechanism will be described with respect to subsequent figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries or even instructions that undergo some translation (such as compilation) before direct execution by the processors, such as intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

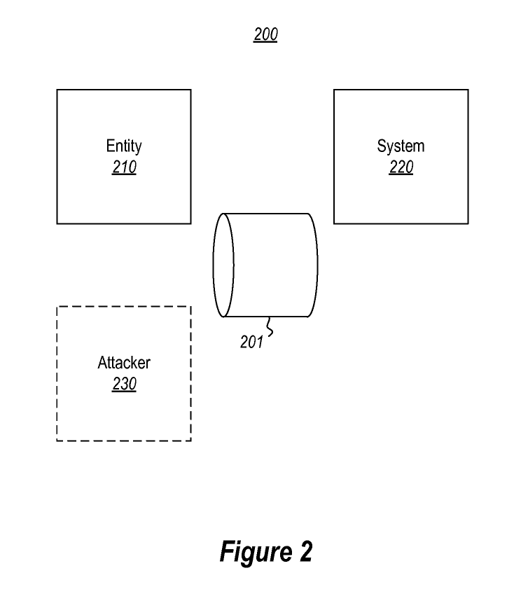

FIG. 2 illustrates authentication environment 200 that includes an authenticating entity 210 and an authentication system 220 that communicate with each other over a channel 201. The authentication environment 200 also includes perhaps an attacker system 230 that might inappropriately attempt to authenticate to the authentication system 220 purporting to be the authenticating entity 210. Of course, in an ideal world, attacking computing systems such as this would not exist. Nevertheless, authentication systems do account for the risk that attacker systems exist for various nefarious purposes. Accordingly, to emphasize that the attacker system 230 is not a part of the desired part of the authentication environment 200, the attacker system 230 is illustrated with dashed lines.

The authenticating entity 210 and the authentication system 220 (as well as the attacker system 230, if any) may be any computing system and may operate, for instance, as described above for the computing system 100 of FIG. 1. That said, the computing entity 210 might also be a portion of a computing system, such as a module, program, component, process, or the like. The authenticating entity might also be a user with the assistance of the computing system, in the sense that the user might be the entity that is authenticated and that perhaps generates the password, with the computing system performing other tasks associated with the computing system. That said, the computing system might also assist a user with password generation.

The authentication environment 200 may be used to support multiple authentication domains between the authenticating entity 210 and the authentication system 220. For instance, one authentication domain may be used when the authenticating entity 210 is acquiring one set of one or more services from the authentication system 220, whilst another authentication domain may be used when the authenticating entity 210 is acquiring another set of one or more services from the authentication system 220. Each authentication domain may have a distinct password, policy, and/or parameters applied during authentication.

The operations within the authentication environment 200 may be broadly divided into two stages of operation. The first stage is the set up stage, in which the authenticating entity 210 and the authentication system 220 collaborate to set up an authentication mechanism. The second stage is an authentication stage, in which the authenticating entity 210 uses the authentication mechanism set up at the first stage in order to authenticate to the authentication system 220.

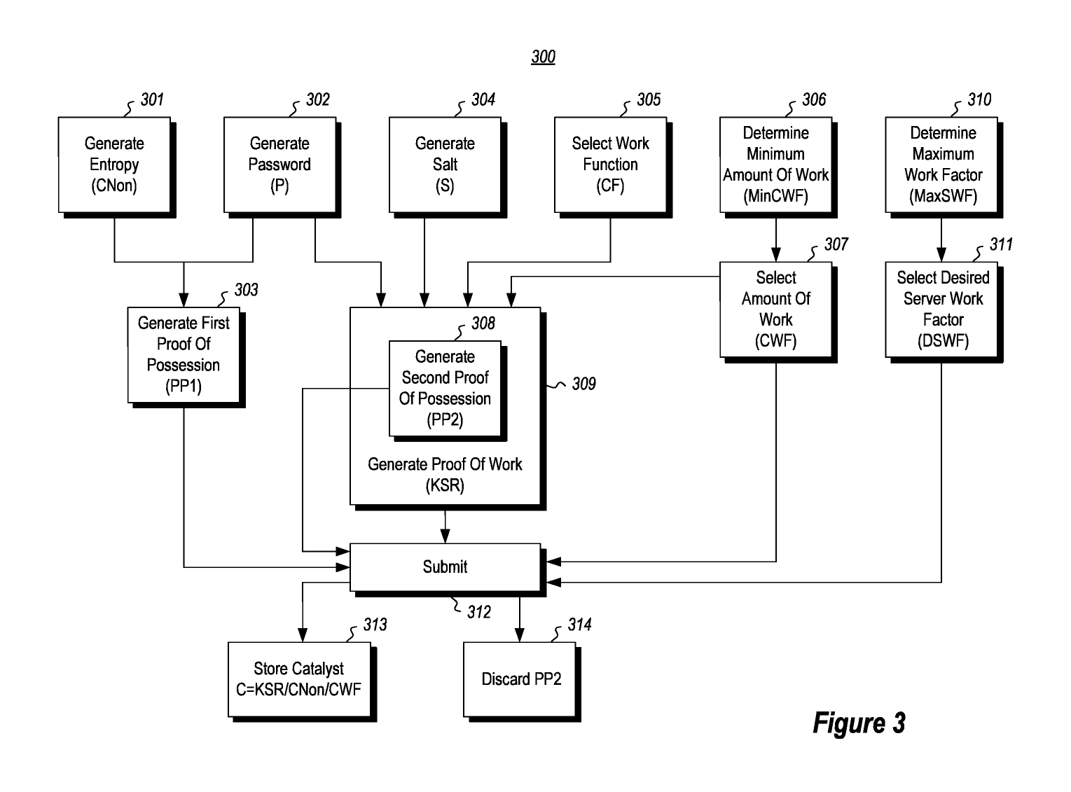

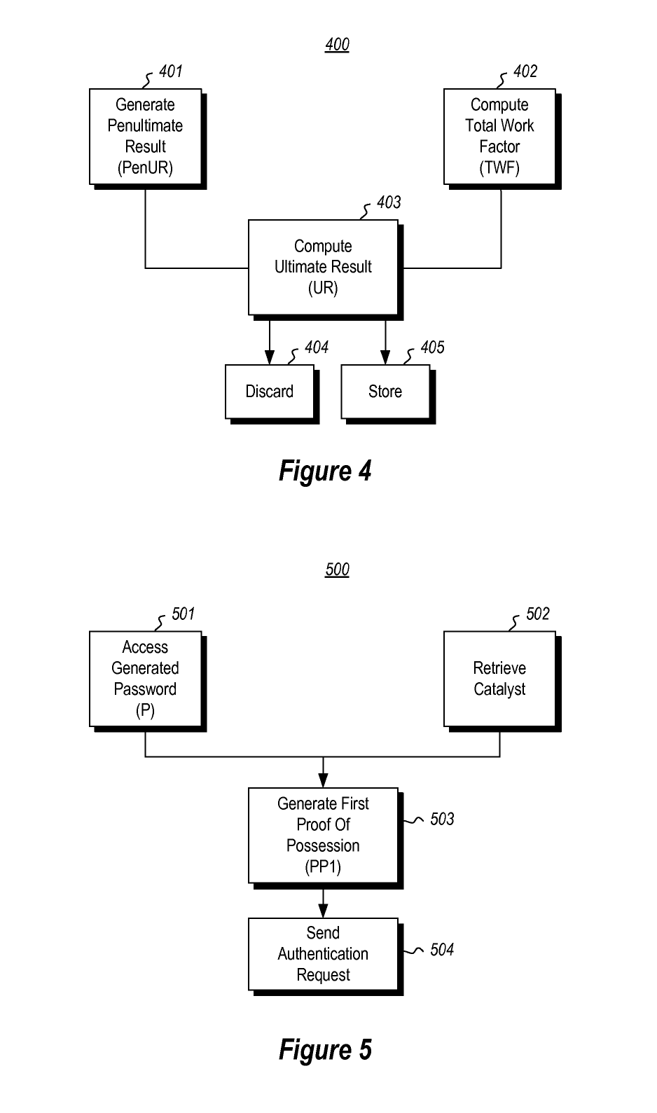

FIGS. 3 and 4 correspond to the first set up stage. FIG. 3 illustrates a flowchart of a method 300 for an authenticating entity to perform its part in setting up an authentication mechanism with an authentication system based on a password. FIG. 4 illustrates a flowchart of a method 400 for an authentication system to perform its part in setting up the authentication mechanism with the authenticating entity. That said, virtualization of computing tasks is becoming ever more prevalent. Accordingly, when tasks are described as being performed by particular computing system herein, it will be understood that such tasks might instead be performed in a virtualized manner by another computing system for and on behalf of the particular computing system.

FIG. 3 again illustrates a flowchart of a method 300 for an authenticating entity to perform its part in setting up an authentication mechanism with an authentication system based on a password. For instance, the method 300 might be performed by the authenticating entity 210 of FIG. 2.

The authenticating entity generates entropy (act 301), such as a pseudo random number (symbolized by “CNon” in equations that follow). The entropy (e.g., the pseudo random number) is generated by a cryptographically secure source of entropy, such as a cryptographically secure random number generator.

The authenticating entity also generates a password (act 302) (symbolized by “P” in the equations that follow). The authenticating entity need not provide the password itself to the authentication system either during set up, or even during authentication itself. Mere possession of the password is sufficient as far as the authentication mechanism is concerned.

The authenticating entity then generates a first proof of possession of the password (act 303) (symbolized by “PP1” in the equations that follow). This proof of possession represents proof that the authenticating entity is indeed in possession of the password, and may be subsequently provided also to demonstrate such possession at subsequent times also. The first proof of possession PP1 may be a fast calculation based on the pseudo random number (CNon) and the password (P). The proof of possession PP1 is a provably secure calculation of the password (P) such as a one-time pad, defined by the following equation 1:

PP1=P×or CNon (1)

The authenticating entity also generates a salt (S) (act 304). A “salt” in the field of cryptography is a piece of data that is typically provided along with a password to a one way function. Often the piece of data is a pseudo random number, or perhaps just a number for which some attempt has been made at uniqueness.

The authentication entity also selects a work function (act 305) (symbolized by “CR” in the equations below). The work function CF may take as input H(P|S) (the hash value of the combination of the password concatenated with the salt), to generate an output. That output may again be fed to the client function, and so on, and so forth, for a particular number of times. The client function might be, for example, scrypt (read “S crypt”) or simply iterative hashing. In one embodiment, the work factor CF scales approximately linearly in space and time with the number of times that the client function is performed. For instance, performing the work function iteratively ten times might take about ten times as much time as performing the work function once. The authenticating entity will provide proof of work by iteratively performing the work function a certain number of times, each time on the result of the prior iteration of the work function.

The authenticating entity might determine a minimum amount of authenticating entity proof of work (MinCWF) specified by the authentication system. (act 306). This might be represented in a form of how many times the work function should be iteratively performed by the authenticating entity. Thus, the authentication system might enforce how much work is the minimum to be proved. Recall that this proof of work makes it difficult for attacker systems to just randomly guess passwords, since each guess comes at the price of having to provide a proof of work. Accordingly, a higher value for the minimum amount of authenticating entity proof of work results in a greater barrier for such attackers. A legitimate authenticating entity also has to provide the proof of work, but only once assuming they keep the same password and assuming they do not lose the proof of work. The authenticating entity then selects an amount of work (CWF) (act 307) of the proof of work that is greater that is greater than the minimum amount of authenticating entity proof of Work (MinCWF).

At this point, the authenticating entity is aware of the password (P), the salt (S), the work function (CF), the number of times the work function is to be iteratively performed (CWF). Accordingly, on its way to generating a proof of work (act 309), the authenticating entity generates a second proof of possession (act 308) (symbolized by “PP2” in accordance with the following Equation (2):

PP2=H(CF^{CWF}(H(P|S)) (2)

This means that the first iteration of the work function CF takes as input a hash of the concatenation of the password P with the salt S. Subsequent iterations of the work function CF takes the output from the previous iteration of the work function CF until the work function is iterated CWF times to output the second proof of possession PP2. Thus, the second proof of possession PP2 uses more processing to generate than the first proof of possession PP1 and may even be thought of as an intermediate proof of work. In fact, in one embodiment, in order to generate the proof of work (act 309) (symbolized as KSR in the equations), the authentication system just hashes the second proof of possession PP2.

In some embodiments, the authentication system 220 also performs some iterations of hashing. The authenticating entity 211 determines a maximum amount of authentication system work factor (MaxSWF) specified by the authentication system (act 310). This represents a maximum limit on the number of further hashing iterations that the authentication system 220 is going to do. For instance, without such a maximum, then the workload of the authentication system 220 simply might not scale well to multiple entities trying to authenticate to it. It is advantageous to have some number of iterations of hashing performed by the authentication system so as to protect against a security failure in the authenticating entity.

The authenticating entity then selects an authentication system work factor (act 311) (symbolized as DSWF in the equations) to be exercised by the authentication system when the authentication system performs further work based on the proof of work to thereby compute a result of the further work that may be used in comparison to perform subsequent authentications of the authenticating entity. This selected authentication system work factor DSWF is less than or equal to the maximum authentication system work fact MaxSWF.

The authenticating entity 210 may then submit the following authentication mechanism establishment data (act 312) to the authentication system 220: a username, the proof of work KSR, the first proof of possession PP1, the second proof of possession PP2, the salt S, the authenticating entity work factor (CWF), and the authentication system work factor (DSWF).

Furthermore, at some point before or after the submission of act 312, the authenticating entity stores the proof of work (act 313) for subsequent authentications to the authentication system. For instance, in act 313, the authenticating entity stores a “catalyst” which is data that includes the proof of work KSR, the entropy CNon, and the authenticating entity work factor CWF. As will be demonstrated below, access to the proof of work prevents the authenticating entity from having to regenerate the proof of work on subsequent authentications to the authentication system.

The authenticating entity also discards the second proof of work PP2 (act 314). This is for security reasons to prevent the illicit use of that second proof of work PP2 should it fall into the wrong hands.

FIG. 4 illustrates a flowchart of a method 400 for an authentication system to perform its part in setting up the authentication mechanism with the authenticating entity. For instance, the method 400 might be performed by the authentication system 220 of FIG. 2.

The authentication system computes a penultimate result (act 401) (symbolized as PenUR in the equations) representing further work on the proof of work. For instance, the penultimate result might be calculated in accordance with Equation 3:

PenUR=H^{DSWF}(KSR) (3)

In other words, the proof of work KSR is hashed, then that result is hashed, and so on and so forth for DSWF number of times. Here, note that the work function performed by the authentication system is different than the work function performed by the authenticating entity. Thus, those functions needed not be the same.

The authentication system also computes a total work factor according to the following Equation 4:

TWF=CWF+DSWF (4)

If performing this equation, the various parameters may be weighted to account for relative difficulty if the work function performed at the authentication system is different than that performed at the authenticating entity.

The computing system then computes the final value or ultimate result (symbolized as UR in the equations) that will be used to compare to the final result from future authentication requests. The final result of the further work UR might simply be a hash of the penultimate result PenUR.

The authentication system then stores the following authentication aids (act 405) for use in future authentication requests from the same authenticating entity or impostors of the same: the ultimate result UR of further work performed on the proof of work KSR, the authenticating entity work factor CWF, the total work factor TWF, the first proof of possession PP1, the second proof of possession PP2, and the salt S. For security reasons, the authentication system discards the proof of work KSR provided by the authenticating entity, and the penultimate result PenUR.

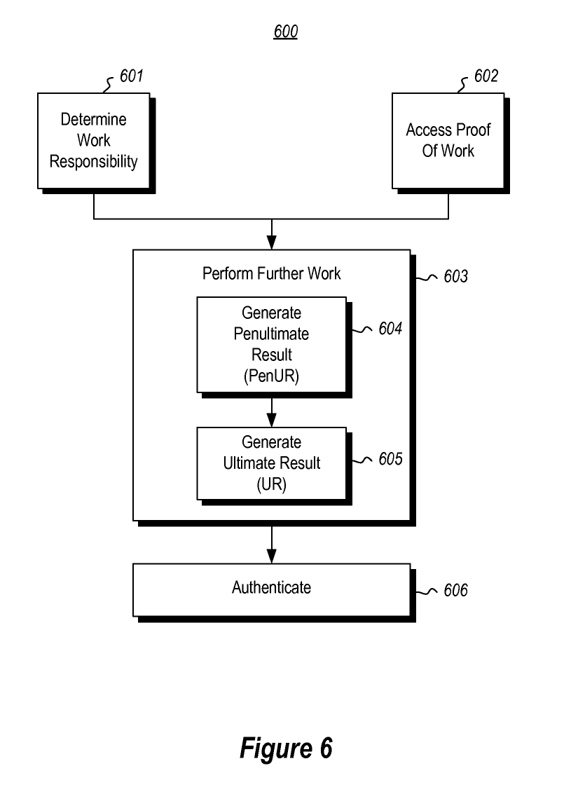

FIGS. 5 and 6 correspond to the second authenticating stage in the case in which the authenticating entity has retained the proof of work KSR. FIG. 5 illustrates a flowchart of a method 500 for an authenticating entity to perform its part in authenticating with an authentication system based on a password and using the authentication mechanism established in FIGS. 3 and 4. FIG. 6 illustrates a flowchart of a method 600 for an authentication system to perform its part in authenticating the authenticating entity using the authentication mechanism established in FIGS. 3 and 4.

The method 500 may be performed by the authenticating entity 210 of FIG. 2. Here, the authenticating entity accesses the generated password (act 501) that was generated in act 302. For instance, if the password is stored in the cloud, another computing system, or on the authenticating entity, the authenticating entity acquires the password. Alternatively, a user who has memorized the password enters the password. The authenticating entity also retrieves (act 502) the catalyst stored in act 313 (which includes the proof of work KSR, the random number CNon, and the authenticating entity work factor CWF, although CWF is not used here).

The authenticating entity then generates the first proof of possession PP1 (act 503) using Equation 1 above. The authentication entity then sends the authentication request (act 504) to the authentication system, the request including anything helpful to perform authentication such as, for example, the username, the proof of work KSR, the first proof of possession PP1, and perhaps an indication of whether or not the authenticating entity as a catalyst (yes in this case). Note that even though a proof of work is provided, this authenticating did not result in the need to re-perform the work, since the same password is being used as was used when the authenticating entity registered with the authentication system in FIGS. 3 and 4.

The method 600 may then be performed by the authentication system 220 of FIG. 2. The authentication system then determines its work responsibility (act 601) by retrieving the authenticating entity work factor CWF (stored in act 405), and the total work factor TWF (also stored in act 405), and computing the authentication system work factor SWF according to the following Equation 5:

SWF=TWF−CWF (5)

The authentication system also access the proof of work PP1 (act 602) from the authentication request. The authentication system may then perform further work (act 603) based on the proof of work by generating the penultimate result PenUR (act 604) as described above for act 401, and generate the ultimate result UR (act 605) as described above for act 403. The authentication system may then authenticate (act 606) by attempting to match the ultimate result UR and the first proof of possession against the values stored in act 405 corresponding to that username.

In some cases, the authenticating entity 210 may have lost the catalyst or a component thereof, or perhaps the authenticating entity 210 is authenticating from a system that just does not have the catalyst. For instance, the authenticating entity 210 may have lost or discarded the proof of work KSR. The principles described herein still permit the authenticating entity to perform authentication albeit by having to repeat the work resulting in the proof of work KSR.

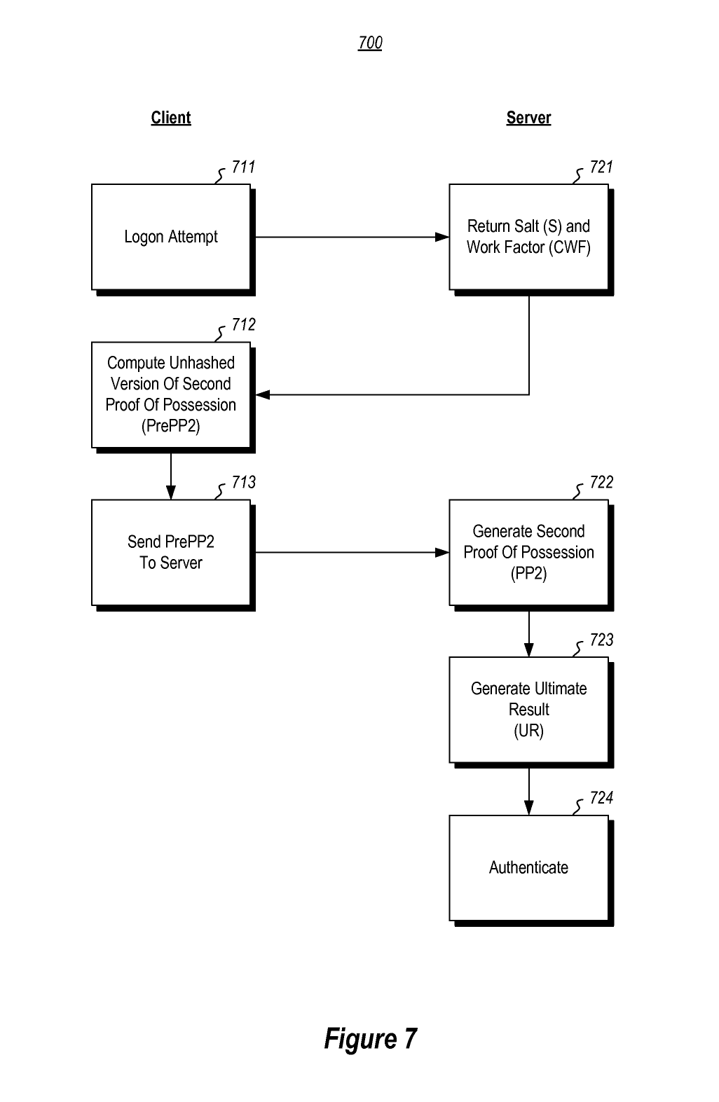

FIG. 7 illustrates a flowchart of a method 700 for authentication when the authenticating entity no longer has the proof of work KSR or the catalyst. Some of the acts of the method 700 are performed by the authenticating entity 210 as represented in the left column of FIG. 7 under the header “Client”. Some of the acts of the method 700 are performed by the authentication system 220 as represented in the right column of FIG. 7 under the header “Server”. Although the proof of work is regenerated, the protocol may be somewhat simplified.

The authenticating entity sends a logon attempt to the authentication system indicating that the authenticating entity does not have a catalyst (act 711). The authentication system returns the salt S and the authentication entity work factor CWF (act 721). The authenticating entity then computes a pre-image (called “PrePP2”) that if hashed would generate the second proof of possession PP2 (act 712) according to Equation 6.

PrePP2=H²(CF^{CWF}(H(P|S)) (6)

Thus, by hashing the pre-image PrePP2 one more time, the authentication system may derive the second proof of possession PP2. The authenticating entity sends this pre-image PrePP2 of the second proof of possession PP2 to the authentication system (act 713). Note that the second proof of work PP2 is not transmitted in the clear.

The authentication system then generates the second proof of possession PP2 (act 722) by hashing the pre-image version PrePP2 of the second proof of possession. The authenticating system then computes the ultimate result UR in accordance with Equation 7 below.

UR=H^{SWF+2}(PP2) (7)

Note that two extra hashes are used to account for the hashes for the proof of work KSR and the penultimate result PenUR. Now, the authentication system may authenticate (act 724) the authenticating entity by comparing the ultimate result UR against the ultimate result stored in act 405.

Suppose now that it was the attacking system 230 that was attempting method 700. An attacker is free to try to guess passwords, but for each guess, the attacker system expends approximately on the order of CWF (or O(CWF)) of work to compute the second proof of possession PP2. Also note that if an attacker has a list of usernames, the attacker can retrieve all of the CWFs (and salts), which facilitates him targeting the weakest accounts. However, by setting a MinCWF, the authentication system can provide a minimum level of security. Additionally, bulk retrieval of CWFs would be more easily detectible to the authentication system.

Finally, note that if the password database is compromised, the attacker will have access to the second proof of possession PP2. Assuming the hash function is irreversible, this is not a problem. In order to guess the password, the attacker will have to go through O(CWF) work to compute PrePP2 for each guess. Using common techniques for password security today, the effort that an attacker has to spend on cracking passwords is proportional to the length of time that a legitimate client is willing to wait for a successful logic every time, which is typically very short.

Note that an authenticating entity that authenticates to the authentication system may choose to establish the kind of authentication mechanism established in FIGS. 3 and 4 in an expedited way during the authenticated session. Then, this established authentication mechanism may be used in subsequent authentication attempts.

While the authenticating entity is authenticated in any way to the authentication system, the authenticating entity acquires a unique user identifier N, and retrieves the maximum authentication system work factor MaxSWF. The authenticating system then chooses a desired server work factor D. The authenticating system then generates a salt and performs the following equation in order to generate a proof of work:

AR=H(N−D)(H(p|s)) (8)

In some embodiments, when an authenticating entity provides incorrect authentication credentials to the authentication entity, the protocol may increase the amount of work to be performed to generate the next proof of work. Accordingly, attackers attempting a variety of passwords would find it progressively harder the more time they try to guess the authenticating entity's password.

The authenticating entity can authenticate with knowledge of the password, and nothing more, thus avoiding some usability problems with certificates. Furthermore, by choosing a small authentication system work factor SWF, the authenticating entity can speed up any authentications after the first. Furthermore, by choosing a large authenticating entity work factor, the authenticating entity can make an attacker's job arbitrarily difficult for an offline attack. Furthermore, online attacks are far less likely to succeed. Also, the loss of the catalyst does not create a security concern because knowledge of the password is still required. Heavy computational work is pushed to the authenticating entities thereby allowing the authentication system to scale. Furthermore, the work required may be increased after failed authentication attempts thereby providing attackers with a progressively harder experience the more time they try to guess the authenticating entity's password.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable storage media having thereon computer-executable instructions that are structured such that, when executed by one or more processors of a computing system, cause the computing system to perform a method for an authenticating entity setting up an authentication with an authentication system based on a password, the method comprising:
an act of accessing a generated password;
an act of generating a proof of work based on the generated password;
an act of generating a proof of possession of the password using the generated password; and
an act of submitting the proof of work and the proof of possession to an authentication system.

2. The computer program product in accordance with claim 1, the method further comprising:
an act of selecting an amount of work of the proof of work that the authenticating entity confirms is greater than a minimum amount of authenticating entity proof of work specified by the authentication system.

3. The computer program product in accordance with claim 2, the method further comprising:
an act of selecting a work function, and an amount of times to iteratively perform the work function to thereby accomplish the selected amount of work; and
an act of causing the selected work function to be identified to the authentication system.

4. The computer program product in accordance with claim 1, the method further comprising:
an act of selecting an authentication system work factor to be exercised by the authentication system when the authentication system performs further work based on the proof of work to thereby compute a result of the further work that may be used in comparison to perform subsequent authentications of the authentication system; and
an act of submitting the authentication system work factor to the authentication system.

5. The computer program product in accordance with claim 4, the act of selecting further comprising:
an act of verifying that the authentication system work factor is no more than a maximum authentication system work factor specified by the authentication system.

6. The computer program product in accordance with claim 1, the method further comprising:
an act of storing the proof of work for subsequent authentications to the authentication system.

7. The computer program product in accordance with claim 1, the proof of possession being a first proof of possession, the proof of work being an authenticating entity proof of work, the act of generating a proof of work based on the generated password further comprising:
an act of generating a second proof of possession that represents an intermediate proof of work based on the password, wherein further work may be performed on the intermediate proof of work to generate the authenticating entity proof of work.

8. The computer program product in accordance with claim 7, wherein on one or more subsequent authentication attempts of the authenticating entity to the authentication system, if the authenticating entity does not have the proof of work, the authenticating entity generates the second proof of possession in order to perform authentication.

9. The computer program product in accordance with claim 7, the method further comprising:
an act of submitting the second proof of possession to the authentication system; and
an act of discarding the second proof of possession in response to the act of submitting the second proof of possession to the authentication system.

10. The computer program product in accordance with claim 7, the second proof of possession using more processing to complete than the first proof of possession.

11. The computer program product in accordance with claim 10, the second proof of possession created using a same work function as is used to create the proof of work.

12. The computer program product in accordance with claim 1, wherein on one or more subsequent authentication attempts of the authenticating entity to the authentication system, if the authenticating entity does not have the proof of work, the authenticating entity generates the proof of work in order to perform authentication.

13. A computing system comprising:
one or more processors;
one or more computer-readable storage media having thereon the following:
a proof of work based on a password; and
computer-executable instructions that, when executed by the one or more processors of the computing system, cause the computing system to perform a method for authenticating the computing system or its user, the method comprising:
an act of accessing a generated password;
an act of generation a proof of possession of the password using the generated password; and
an act of submitting the proof of work and the proof of possession for authentication.

14. A method for an authentication system to authenticate in response to an authentication request purportedly received from an authenticating entity, the method comprising:
an act of accessing a proof of work associated with the authentication request, the proof of work demonstrating that the authenticating entity performed work based on a password;
an act of accessing a proof of possession of the password;
an act of performing further work based on the proof of work; and
an act of authenticating based on whether a result of the further work and the proof of possession of the password matches corresponding values possessed at the authentication system.

15. The method in accordance with claim 14, the corresponding values computed in response to previous negotiations with the authenticating entity subsequent to the authenticating entity selecting a password for use with authenticating with the authentication system.

16. The method in accordance with claim 14, the password itself not being known to the authentication system that performs the method.

17. The method in accordance with claim 14, an amount of the further work being defined by the authenticating entity.

18. The method in accordance with claim 14, a work function to be used to perform the further work being previously specified by the authenticating entity.

19. The method in accordance with claim 14, wherein upon an unsuccessful authentication attempt from the authentication requestor, the authentication system requires the proof of work to be more rigorous by increasing the amount of work associated with generating the proof of work.

20. The method in accordance with claim 14, wherein if the authentication requestor initially requests authentication without the proof of work, the authentication system requires a proof of possession that is more difficult to generate than if the authentication requestor initially requests authentication with the proof of work.
